(19) United States
(12) Patent Application Publication
(10) Pub. No.: US 2026/0058084 A1
(43) Pub. Date: Feb. 26, 2026

(54) Fuse

(71) Applicant: PACIFIC ENGINEERING CORPORATION, Gifu (JP)

(72) Inventors: Kengo Watanabe, Gifu (JP); Yutaka Tsuchiya, Gifu (JP); Yusuke Kondo, Gifu (JP)

(73) Assignee: PACIFIC ENGINEERING CORPORATION, Gifu (JP)

(21) Appl. No.: 19/105,806

(22) PCT Filed: Jun. 7, 2023
(86) PCT No.: PCT/JP2023/021075

§ 371 Date: Feb. 22, 2025

(30) Foreign Application Priority Data
Aug. 25, 2022 (JP) 2022-1133754

(51) Int. Cl. H01H 85/165; H01H 85/143

(52) U.S. Cl. CPC H01H 85/165; H01H 85/143

(57) ABSTRACT

The invention of the present application provides a fuse addressing high voltage and high current while maintaining dimensions of a casing of the fuse. The fuse is a fuse including a casing, terminal parts on respective sides, and a fuse element housed in the casing, in which the fuse element is in a wave shape including a valley part and a crest part while including a fusing part, and the crest part includes a tip part provided with a cutout formed by cutting out an end part of the tip part.

### TECHNICAL FIELD

The present invention relates to a fuse mainly used in an automobile electric circuit or the like, and more particularly to a fuse in which a fuse element is inserted and housed in a casing.

### BACKGROUND ART

A fuse has been conventionally used to protect an electric circuit mounted on an automobile or the like and various electrical components connected to the electric circuit. Specifically, when an unintended overcurrent flows in the electric circuit, a fusing part of a fuse element incorporated in the fuse fuses due to heat generated by the overcurrent to protect the various electrical components by preventing an excessive current from flowing.

The fuse has various types depending on the intended use, and the types include a type described in Patent Literature 1, for example, in which a fuse element is inserted into a casing in a tubular shape and is held. In recent years, fuses capable of addressing high voltage and high current have been demanded, so that the fusing part may be increased in number, or the fuse element may be increased in total length. However, when the fuse element is complicated in configuration by increasing the fusing part in number or increasing the fuse element in total length, the fuse element tends to increase in width, length, height, and the like as a whole. This trend causes also a problem of increasing the casing for housing the fuse element.

### CITATIONS LIST

### Patent Literature

Patent Literature 1: JP 2012-43573 A

### SUMMARY OF INVENTION

### Technical Problems

In view of the above problems, the present invention provides a fuse for addressing high voltage and high current while maintaining dimensions of a casing.

### Solutions to Problems

A fuse according to the invention of the present application has a feature including a casing, terminal parts on respective sides, and a fuse element housed in the casing, in which the fuse element is in a wave shape including a valley part and a crest part while including a fusing part, and the crest part includes a tip part provided with a cutout formed by cutting out an end part of the tip part.

According to the above feature, even when the fuse element is complicated in configuration to be able to address high voltage and high current, the cutout is provided to prevent an end part of the crest part of the fuse element from interfering with an opening and an inner surface of the casing and obstructing insertion and housing of the fuse element. As a result, the casing is not required to be enlarged, so that dimensions of the casing can be maintained.

The fuse according to the invention of the present application still has a feature in which the fusing part is aligned along a center line connecting connection end parts on respective sides of the fuse element.

According to the above feature, the fusing part is disposed at a position away from the inner surface of the casing, so that an arc generated in the fusing part is efficiently extinguished by an arc-extinguishing material or the like, which is provided in the casing, at a position away from the inner surface of the casing.

The fuse according to the invention of the present application still has a feature in which the fusing part is provided in the valley part of the fuse element.

According to the above feature, the fusing part is provided in the valley part, and thus is disposed at a position away from the inner surface of the casing. Thus, the arc generated in the fusing part is efficiently extinguished by the arc-extinguishing material or the like, which is provided in the casing, at a place away from the inner surface of the casing.

The fuse according to the invention of the present application still has a feature in which the crest part is provided protruding only on one side from the center line connecting the connection end parts on the respective sides of the fuse element.

According to the above feature, the fuse element can be easily inserted through the opening of the casing.

### Advantageous Effects of Invention

As described above, the fuse of the invention of the present application is capable of addressing high voltage and high current while maintaining the dimensions of the casing.

### BRIEF DESCRIPTION OF DRAWINGS

FIG. 1 is an exploded general perspective view of a fuse according to the invention of the present application.

FIG. 2(a) is a plan view of a fuse element, FIG. 2(b) is a side view of the fuse element, and FIG. 2(c) is a front view of the fuse element.

FIG. 3 is a general perspective view of an assembled fuse.

FIG. 4(a) is a side view of a fuse, and FIG. 4(b) is a plan view of the fuse.

FIG. 5(a) is a sectional view taken along line A-A of FIG. 4, and FIG. 5(b) is a sectional view taken along line B-B of FIG. 4.

### REFERENCE SIGNS LIST

100 casing
200 fuse element
220 valley part
230 crest part
231 tip
234 end part
235 cutout
240 fusing part
300 terminal part
900 fuse

### DESCRIPTION OF EMBODIMENT

Hereinafter, an embodiment of the invention of the present application will be described with reference to the drawings. The embodiment described below shows a shape, a material, and the like of each member of a fuse, which are merely examples, and thus the invention of the present application is not limited thereto. Then, a “vertical direction” described herein is a direction perpendicular to a longitudinal direction of a fuse element.

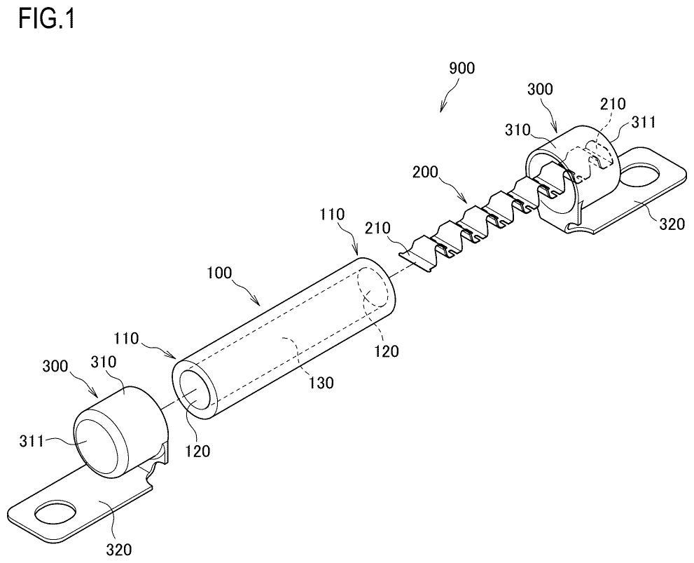

First, a fuse 900 of the invention of the present application is illustrated in FIG. 1. FIG. 1 is an exploded general perspective view of the fuse 900.

As illustrated in FIG. 1, the fuse 900 includes a casing 100, a fuse element 200 housed in the casing 100, and terminal parts 300 connected to respective ends of the fuse element 200. The casing 100 has a cylindrical shape having openings 120 at end parts 110 on respective sides, and is configured to be able to house the fuse element 200 in a housing space 130 inside. The casing 100 can be made of various materials such as ceramic and synthetic resin.

The casing 100 is not limited to a cylindrical shape having a circular cross section, and may have any shape such as a box shape having a quadrangular cross section as long as the casing 100 includes the openings 120 allowing insertion of the fuse element 200 into the inside of the casing 100.

Each of the terminal parts 300 is made of metal, and includes a cap part 310 fitted to the end part 110 of the casing 100 from the outside, and a connection part 320 in a flat shape connected to an external electric circuit. In a state where the cap part 310 is fitted to the end part 110 of the casing 100, a side surface 311 of the cap part 310 can close corresponding one of the openings 120 of the casing 100.

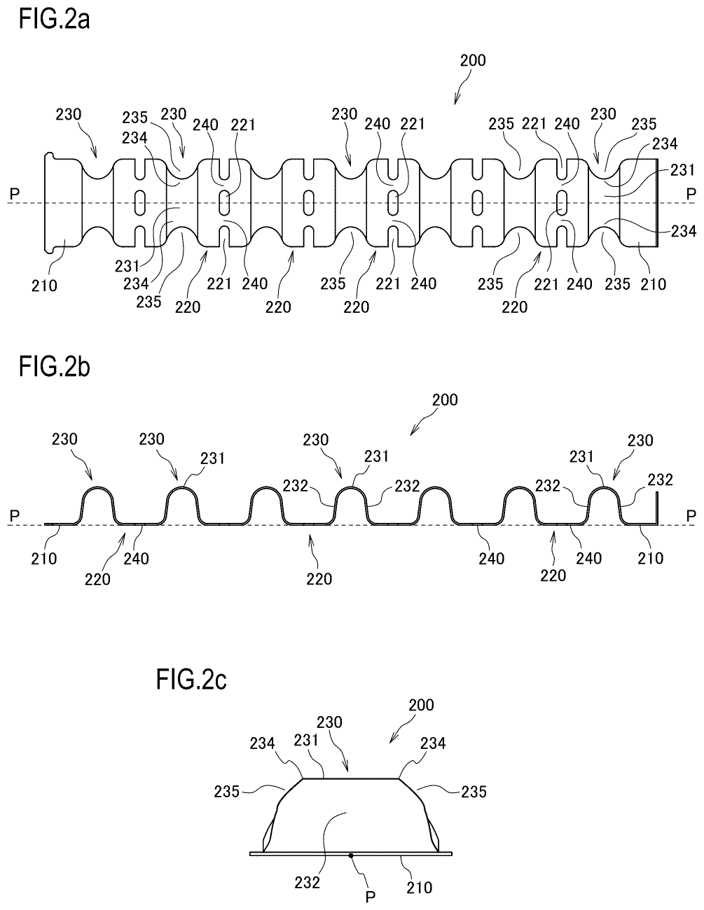

Next, a configuration of the fuse element 200 will be described in detail with reference to FIG. 2. FIG. 2(a) is a plan view of the fuse element 200, FIG. 2(b) is a side view of the fuse element 200, and FIG. 2(c) is a front view of the fuse element 200.

As illustrated in FIG. 2, the fuse element 200 is formed in an elongated shape from one metal plate in the shape of a thin plate, and includes a pair of connection end parts 210 being flat, and valley parts 220 and crest parts 230 between the connection end parts 210, the valley parts 220 and the crest parts 230 forming a wave shape. The valley parts 220 and the crest parts 230 are formed by bending the one metal plate in the shape of a thin plate in a wave shape. The valley parts 220 are each a flat surface and are parallel to a center line P connecting the connection end parts 210 on respective sides. Each valley part 220 is provided with fusing parts 240, and the fusing parts 240 are formed by forming a plurality of small holes 221. Each fusing part 240 is aligned along the center line P connecting the connection end parts 210 on the respective sides.

The crest parts 230 are provided between the corresponding valley parts 220, the crest parts 230 each protruding in a substantially U-shape from the corresponding one of the valley parts 220 in side view.

The crest parts 230 each includes a tip part 231 and side surfaces 232 extending from the tip part 231 to respective sides and connected to the corresponding valley parts 220. As illustrated in FIG. 2(b), the crest parts 230 each protrude only on one side (upper side in the drawing) from the center line P connecting the connection end parts 210 on the respective sides in side view.

The tip part 231 of each of the crest parts 230 is provided with a cutout 235 formed by cutting out an end part 234 of the tip part 231. As illustrated in FIG. 2(a), the end part 234 of each of the crest parts 230 specifically constitutes end parts 234 located on respective sides from the center line P in plan view, and the end part 234 is cut out in a substantially U-shape toward the center line P, or inward, and the cutout part serves as the cutout 235.

As illustrated in FIG. 2, the fusing part 240 is provided only in each of the valley parts 220 and is not provided in each of the crest parts 230. The crest parts 230 each protrude only on the one side (upward in the drawing) from the center line P connecting the connection end parts 210 on the respective sides in side view as illustrated in FIG. 2(b). Besides this, the crest parts 230 may protrude to respective sides (upward and downward in the drawings) from the center line P. The cutouts 235 are provided in the end parts 234 on respective sides of the tip part 231 of each of the crest parts 230 as illustrated in FIG. 2(a). Besides this, the cutout 235 may be provided only in the end part 234 on one side of the tip part 231.

As illustrated in FIG. 2, the fuse element 200 includes the plurality of fusing parts 240. Additionally, the fuse element 200 has a wave shape, so that the fuse element 200 is increased in total length, in other words, a total length of a path of current flowing through the fuse element 200 is increased. Thus, the fuse 900 of the invention of the present application is capable of addressing high voltage and high current. The number of the fusing parts 240 of the fuse element 200 and the number of waves including the valley parts 220 and the crest parts 230 may be any number other than those illustrated in FIG. 2.

As illustrated in FIG. 1, when the fuse 900 is assembled, the fuse element 200 is inserted and housed in the casing 100 from one opening 120 of the casing 100.

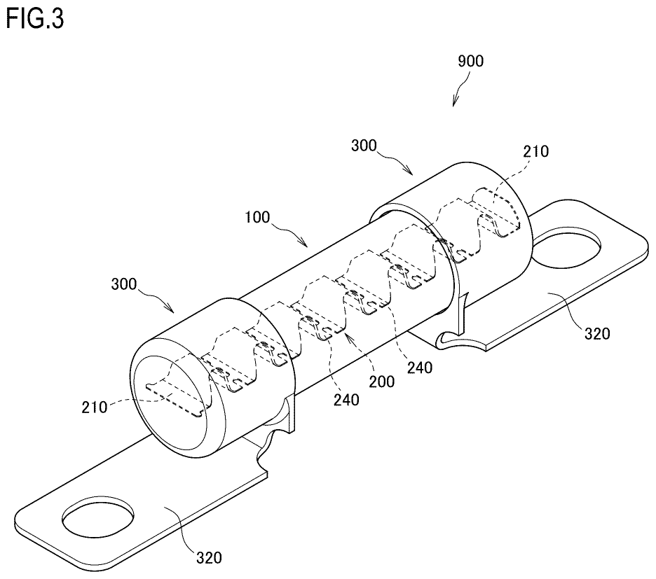

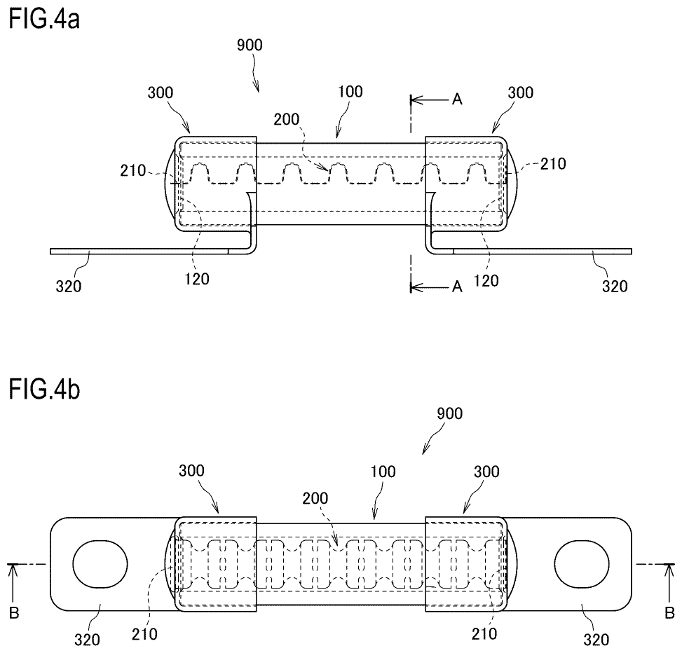

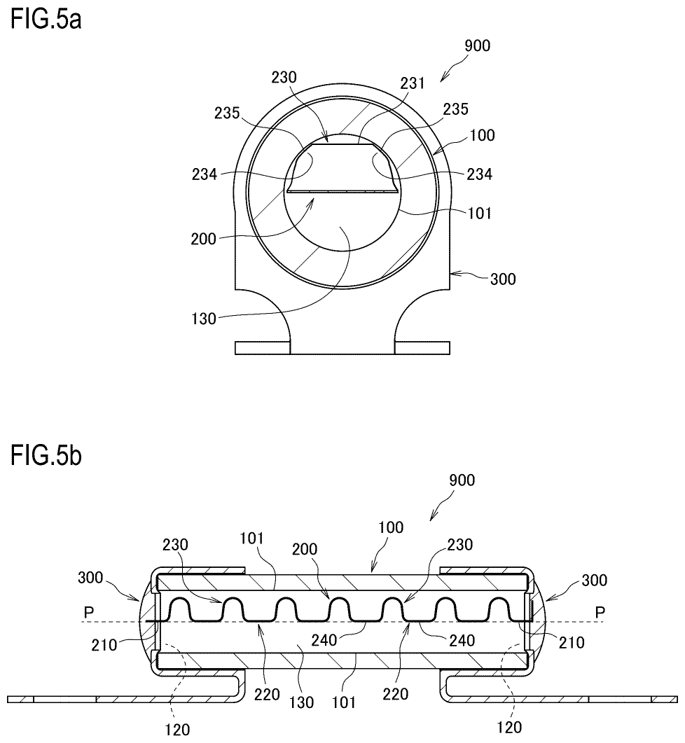

Next, the terminal parts 300 are attached to the end parts 110 on respective sides of the casing 100 to close the openings 120, and then assembly of the fuse 900 is completed as illustrated in FIGS. 3 to 5. FIG. 3 is a general perspective view of the fuse 900, FIG. 4(a) is a side view of the fuse 900, FIG. 4(b) is a plan view of the fuse 900, FIG. 5(a) is a sectional view taken along line A-A of FIG. 4, and FIG. 5(b) is a sectional view taken along line B-B of FIG. 4.

As illustrated in FIGS. 3 to 5, the fuse 900 is assembled in which the connection end parts 210 on respective sides of the fuse element 200 are electrically connected to the respective terminal parts 300. The fuse 900 is mounted by electrically connecting the connection parts 320 of the respective terminal parts 300 to the electric circuit. Then, current flowing through the electric circuit flows from one of the terminal parts 300 to the other of the terminal parts 300 through the fuse element 200. When an unintended overcurrent flows through the electric circuit or the like, the fusing parts 240 of the fuse element 200 housed in the casing 100 generate heat and fuses to cut off the overcurrent. The casing 100 internally encloses arc-extinguishing material in a granular form, so that the arc-extinguishing material is filled around the fuse element 200. Thus, an arc generated when the fusing part 240 is fused is quickly extinguished by the arc-extinguishing material surrounding.

As illustrated in FIG. 5, the casing 100 in a cylindrical shape has a circular shape in vertical section. The fuse element 200 is housed in the housing space 130 of the casing 100 such that the crest parts 230 of the fuse element 200 are in contact with or very close to an inner surface 101 in a circular shape of the casing 100. As described above, when each of the crest parts 230 of the fuse element 200 is bent until being in contact with or very close to the inner surface 101 of the casing 100, each of the crest parts 230 can be greatly bent upward to the limit. As a result, the fuse element 200 can be more increased in total length.

Then, the cutout 235 is provided at the end part 234 of the tip part 231 of each of the crest parts 230. Thus, even when each of the crest parts 230 of the fuse element 200 is bent to be in contact with or very close to the inner surface 101 of the casing 100, the end part 234 of each of the crest parts 230 is prevented from interfering with the opening 120 or the inner surface 101 of the casing 100 and obstructing insertion and housing of the fuse element 200 when the fuse element 200 is inserted and housed in the casing 100 through the opening 120. As described above, the fuse 900 of the invention of the present application enables a fuse element to be prevented from interfering with the casing 100 even when the fuse element is complicated in configuration to be able to address high voltage and high current. As a result, the casing 100 is not required to be increased in size, and thus dimensions of the casing 100 can be maintained.

As illustrated in FIG. 5(b), the fusing part 240 is provided in each of the valley parts 220, and thus is disposed at a position away from the inner surface 101 of the casing 100. Thus, an arc generated in the fusing part 240 is efficiently extinguished by an arc-extinguishing material or the like, which is provided in the casing 100, at a place away from the inner surface 101 of the casing 100.

Additionally, each fusing part 240 is aligned along the center line P connecting the connection end parts 210 on the respective sides, and thus is effectively disposed at a position away from the inner surface 101 of the casing 100. Thus, the arc generated in the fusing part 240 is efficiently extinguished by the arc-extinguishing material or the like, which is provided in the casing 100, at a place away from the inner surface 101 of the casing 100. Each fusing part 240 is aligned parallel to and along the center line P connecting the connection end parts 210 on the respective sides. Besides this, each fusing part 240 may be disposed at an arbitrary position in an arbitrary orientation. Additionally, the fusing part 240 is provided only in each of the valley parts 220 and is not provided in each of the crest parts 230. Besides this, the fusing part 240 may be provided at any position of the fuse element 200 such as the valley part 220 or the crest part 230.

As illustrated in FIG. 5(b), the crest parts 230 each protrude only on the one side (upper side in the drawing) from the center line P connecting the connection end parts 210 on the respective sides, so that the fuse element 200 can be easily inserted from the opening 120 of the casing 100.

The fuse element 200 is formed of the one metal plate in the shape of a thin plate. Besides this, it may be formed of a plurality of metal plates. The fuse 900 includes one fuse element 200. Besides this, it may include a plurality of fuse elements 200. The fuse element 200 is provided with a plurality of small holes to form the fusing parts 240. Besides this, the fusing parts 240 may be formed by locally reducing each of the valley parts 220 in thickness, or by depositing a low melting point metal made of tin, lead, silver, nickel, an alloy thereof, or the like in a narrow part of each of the valley parts 220, for example. Additionally, a material such as silicon may be attached to a part bent in a U-shape behind the crest part 230.

The fuse of the invention of the present application is not limited to the above embodiment, and various modifications and combinations can be made within the scope of the claims and the scope of the embodiment, and these modifications and combinations are also included in the scope of the right of the invention.

1. A fuse comprising:
a casing;
terminal parts on respective sides;
and
a fuse element housed in the casing,
wherein the fuse element is in a wave shape including a valley part and a crest part while including a fusing part, and the crest part includes a tip part provided with a cutout formed by cutting out an end part of the tip part.

2. The fuse according to claim 1, wherein the fusing part is aligned along a center line connecting connection end parts on respective sides of the fuse element.

3. The fuse according to claim 1, wherein the fusing part is provided in the valley part of the fuse element.

4. The fuse according to claim 1, wherein the crest part is provided protruding only on one side from the center line connecting the connection end parts on the respective sides of the fuse element.

5. The fuse according to claim 3, wherein the crest part is provided protruding only on one side from the center line connecting the connection end parts on the respective sides of the fuse element.
